(19) United States
(12) Patent Application Publication
(10) Pub. No.: US 2009/0079542 A1
(43) Pub. Date: Mar. 26, 2009

(54) RFID tag and method for spacing an RFID tag

(76) Inventor: Rochelle L. Heinl, Tipp City, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 11/903,429

(22) Filed: Sep. 21, 2007

(51) Int. Cl. H04B 7/00; B29C 65/50; G06K 19/00

(52) U.S. Cl. 340/10.1; 156/227; 156/60; 235/487

(57) ABSTRACT

An RFID tag comprising a label material including a printing surface and an adhesion surface opposite the printing surface, the adhesion surface including an adhesive operative to mount at least one RFID inlay to the label material, the label material also including deformation indicia for a user to deform the label material to perpendicularly space the RFID inlay from the printing surface. The invention also includes a method of fabricating an RFID tag comprising: (a) printing onto a printing surface of a label material, where the printing surface is defined in party by an X-Y plane; (b) encoding an RFID chip concurrent with the act of printing; (c) removing at least a portion of a backing material from an adhesive layer of the label material to expose an adhesive applied to the label material; and (d) deforming a portion of the label material onto itself, thereby trapping the RFID inlay between the label material so that the RFID is spaced apart in a Z-axis direction from the X-Y plane of the printing surface between 3 to 10 millimeters.

### INTRODUCTION TO THE INVENTION

A challenge to widespread application of radio frequency identification (“RFID”) tags, radio frequency electronic article surveillance (“RF-EAS”) tags, and other electronic labels (collectively “smart labels”) is providing adequate spacing between the item-to-be-tracked and the radio frequency inlay of the smart label. This is particularly the case where the tag is to be applied to metals or items containing water-based liquids.

Metal objects reflect radio waves, while liquids generally absorb radio waves. In an instance where a smart label is placed too close to a metallic item or liquid, the smart label reader (i.e., scanner) detects signals that create background noise signals that hamper proper identification of the intended signals emitted from the smart label. In other words, liquids absorb (do not reflect) the RF signals, whereas metals reflect the RF signals in directions away from the RF scanner.

The present invention overcomes some of these prior art deficiencies by positioning the inlay/transponder a distance away from the items allowing the reader to receive smart label signals. The invention also utilizes a high speed fabrication process to form the smart labels. A more thorough understanding of the invention will be apparent upon reference to the Detailed Disclosure of the Invention.

### BRIEF DESCRIPTION OF THE DRAWINGS

FIG. 1 is an elevated perspective view of a first exemplary embodiment of a smart label in accordance with the present invention;

FIG. 2 is a plan view of an exemplary label material for use with the exemplary embodiment FIG. 1;

FIG. 3 is a plan view of the exemplary embodiment of FIG. 1, shown in the upright position;

FIG. 4 is a plan view of the exemplary embodiment of FIG. 1, shown in a compressed position;

FIG. 5 is an overhead view of the exemplary label material of FIG. 2, prior to fabrication of the embodiment of FIGS. 1 and 3;

FIG. 6 is a plan view of an exemplary folding step in accordance with fabricating the smart tag of FIGS. 1 and 3;

FIG. 7 is a plan view of an exemplary folding step in accordance with fabricating the smart tag of FIGS. 1 and 3;

FIG. 8 is a plan view of an exemplary folding step in accordance with fabricating the smart tag of FIGS. 1 and 3;

FIG. 9 is an elevated perspective view of a second exemplary smart label in accordance with the present invention;

FIG. 10 is an overhead view of an exemplary label material for use with the exemplary embodiment FIG. 9;

FIG. 11 is a bottom view of an exemplary label material, without the backer/liner, for use with the exemplary embodiment FIG. 9; and

FIG. 12 is a plan view of the second exemplary smart label.

### DETAILED DESCRIPTION

The exemplary embodiments of the present invention are described and illustrated below to encompass methods, and items for carrying out such methods, for use in the manufacture, production, and application of smart labels. Of course, it will be apparent to those of ordinary skill in the art that the preferred embodiments discussed below are exemplary in nature and may be reconfigured without departing from the scope and spirit of the present invention. However, for clarity and precision, the exemplary embodiments as discussed below include optional steps or sub-methods that one of ordinary skill will recognize as not being a requisite to fall within the scope of the present invention.

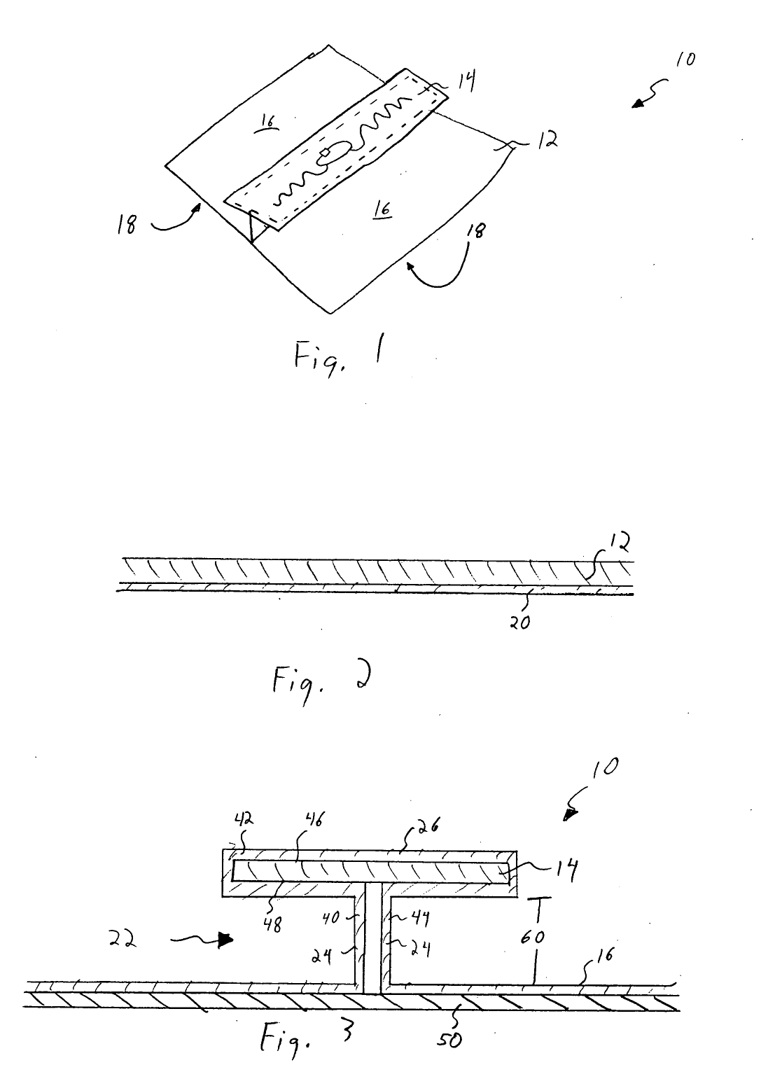

Referencing FIGS. 1-3, a first exemplary smart tag 10 includes a label material 12 and an inlay 14. The label material 12 may be any paper, film, fabric, or laminate, including those suitable as a pressure sensitive label stock, while the inlay 14 includes a radio frequency identification (RFID) component. The smart tag 10 includes a top surface 16 and an underneath surface 18 opposite the top surface. In this first exemplary embodiment, the underneath surface 18 is coated with an adhesive 20 in order to mount the smart tag 10 to the eventual article 50 in question. However, it is to be understood that the adhesive 20 need not be applied to the entire back surface 18.

This first exemplary smart tag 10 includes a T-shaped projection 22 operative to space the inlay 14 from the top surface 16 adjacent to the eventual article 50. As will be discussed in more detail later, this spacing is operative to allow the RFID reader to more accurately read the information disseminated by the RFID component of the inlay 14. In this first exemplary embodiment 10, the projection 22 is fabricated from the label material 12 to include a repositionable spacer 24 and an RFID envelope 26. The spacer (in this first exemplary embodiment in the shape of a wall) 24 extends continuously from the top surface 16 of the label material 12, while the opposite end of the wall 24 continuously extends from the RFID envelope 26. In this manner, the RFID envelope 26 surrounds the inlay 14 using the adhesive 20 on the back surface 16 of the label material 12. For purposes of simplicity in the drawings, the adhesive 20 is not shown in FIG. 3.

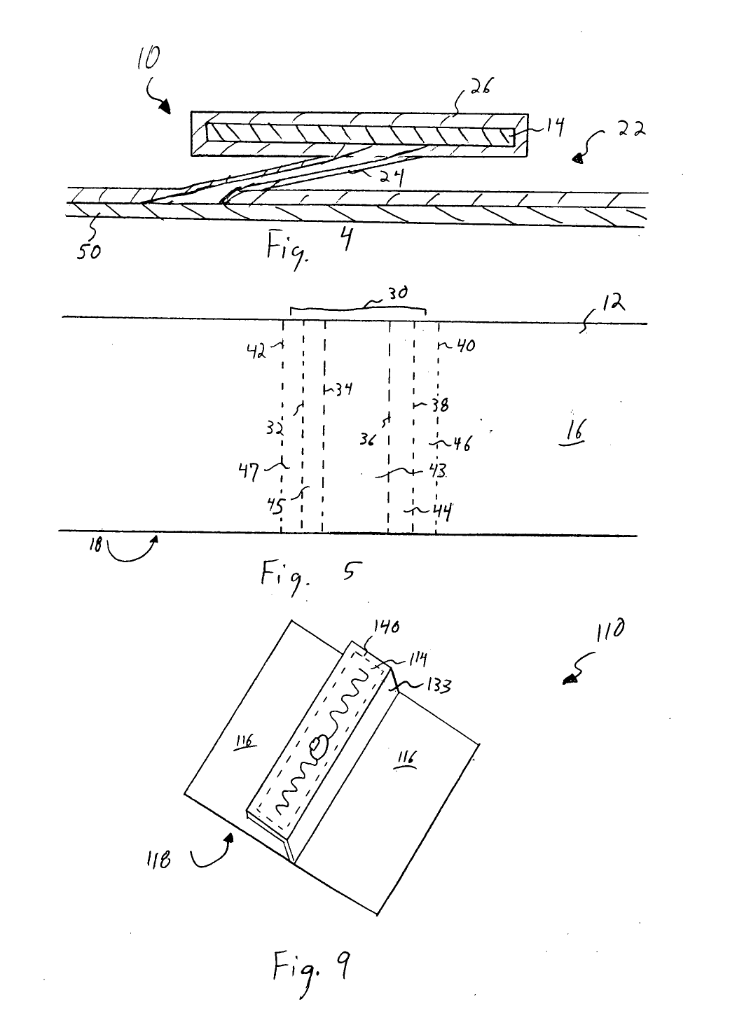

Referring to FIGS. 3 and 4, one of the novel features of the first exemplary smart tag 10 is the flexibility of the projection 22 to be repositioned from an upstanding position (see FIG. 3) to a fully retracted position (see FIG. 4, showing a retracted, but not fully retracted position). For example, when the projection 22 is in its upstanding position, the wall 24 is vertically oriented in a generally perpendicular position with respect to the top surface 16 of the tag 10 adjacent to the eventual object 50, while the RFID envelope 26 is horizontally oriented in a generally parallel position with respect to the top surface 16. Conversely, when the projection 22 is in its fully retracted position, the wall 24 and RFID envelope 26 are generally horizontally oriented and in parallel with respect to the top surface 16. This flexibility allows the exemplary smart tags 10 to be stored in the fully retracted position in a stacked manner, where the profile of each tag is substantially flush. At the point in time when the tag 10 is to be mounted to an article, the projection 22 may be repositioned to its upstanding position for end use. Conversely, the tag 10 may be folded just prior to application to the end object 50 so that the projection 22 is oriented in its upstanding position spaced apart from the top surface that will be adjacent to the eventual object 50.

Referencing FIGS. 5-8, fabrication of the first exemplary smart tag 10 includes utilization of the label material 12 having the adhesive 20 applied to the underneath surface 18. While the label material 12 from a vendor may include an adhesive 20 applied to at least one surface, it is also within the scope of the invention to apply adhesive 20 to a label material 12 not otherwise having the same or to apply a second layer of adhesive to label material already having a first adhesive layer. Those skilled in the art are familiar with the equipment and methods for applying an adhesive 20 to a label material 12. In this exemplary embodiment, the underneath surface 18 includes an adhesive 20 layer across substantially the entire surface, while the top surface 16 does not.

The label material 12 includes perforations 30 in a predetermined pattern to facilitate the folding and/or forming of the projection 22. In this exemplary embodiment, the label material 12 includes six repeating perforations 32, 34, 36, 38, 40, 42 that extend substantially the entire width of the label material to form five zones 43, 44, 45, 46, 47 therebetween. These perforations 32, 34, 36, 38, 40, 42 may be formed in the label material 12 prior to, or subsequent to, adhesive application. As will be discussed in more detail hereafter, the perforations 32, 34, 36, 38, 40, 42 also facilitate enveloping the inlay 14.

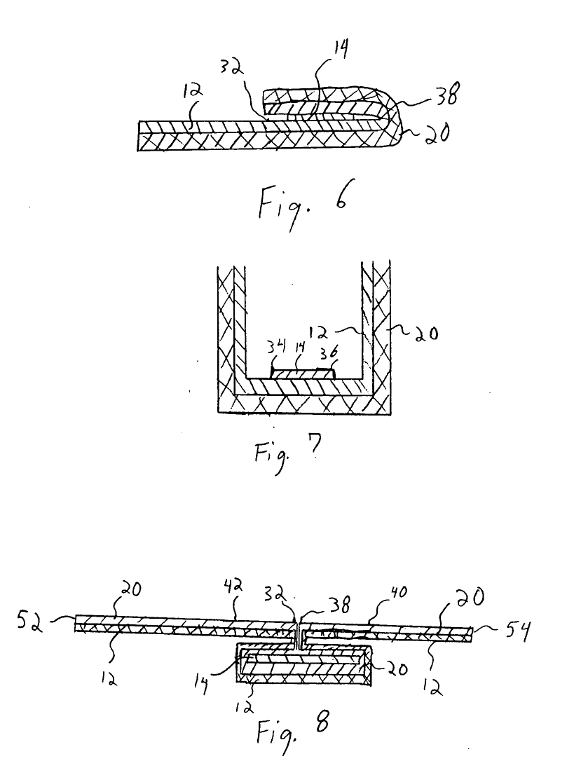

Referring to FIGS. 3 and 6-8, assembly of the first exemplary smart tag 10 includes orienting the label material 12 to expose the adhesive 20 on the underneath surface 18. This may be accomplished by inverting the label material 12 so that the underneath surface 18 faces upward, but need not be as the exemplary process may be carried out with the top surface 16 facing upward. Referencing FIGS. 6 and 7, the tag 10 is folded along the intermediate perforations 32, 38 to pride a generally block U-shape, with the inlay 14 facing upward. Referencing FIG. 8, the label material 12 and adhesive 20 are formed around the inlay 14 so that the inlay 14 is circumferentially enveloped by the adhesive 20 and label material 12. Concurrent with enveloping the inlay, the tag 10 is folded along the two innermost perforations 34, 36 so that the label material is substantially flat. Thereafter, the exposed ends of the label material 52, 54 are pushed inward so that the tag 10 folds along the two outermost perforations 40, 42 so that the adhesive portions between folds 38, 40 and 32, 42 contact one another to form the wall 24. Following this process, the three innermost zones 43, 44, 45 envelope the inlay 14, while the two outermost zones 46, 47 bond to one another to form the wall 24. If the above process is carried out well prior to end use, a tear away backing (not shown) may be applied to the tag 10 to protect against inadvertent adhesion until the tag is ready for end use. As would be apparent to one of ordinary skill in the art, it is not necessary that the entire underneath surface 18 of the label material 12 be coated with the adhesive 20 in order for an exemplary smart tag 10 to be adhered to the product, container or other item 50 that is to be tracked.

Dimensions for the exemplary smart tag 10 may depend on the end application and types of RFID components utilized. However, for purpose of explanation only, the wall 24 has a height of 1-10 millimeters, and a thickness of approximately 0.001-0.030 millimeters, with a length determined in part by the dimensions of the label material 12. Likewise, the RFID envelope 26 has a height of approximately 0.003-0.090 millimeters, and a width of approximately 2-20 millimeters, with a length determined in part by the lengths of the label material 12 and the inlay 14 (which in exemplary form is approximately 100 millimeters). In this exemplary embodiment, the label material 12 has a thickness of approximately 0.004 millimeters.

Referring to FIG. 3, the RFID inlay 14 is spaced from the top surface 16 of the tag 10 to reduce interference. This spacing is referred to as the spacing height 60. Typically, the spacing height 60 is between 1-10 millimeters, but it may depend on the angle between the top surface 16 and the wall 24, as well as the angle between the wall 24 and RFID envelope 26. Where the angle between the top surface 16 and the wall 24, as well as the angle between the wall 24 and the RFID envelope 26, is at a right angle (i.e., perpendicular), the spacing height 60 of the substrate 26 is approximately equal to the height of the wall 22. In this exemplary embodiment, the length of the RFID envelope 26 is greater than twice the height of the wall 24. Having the length of the RFID envelope 26 greater than twice the height of the wall 24 is operative to inhibit the RFID inlay 14 from being oriented perpendicular with respect to the top surface 16.

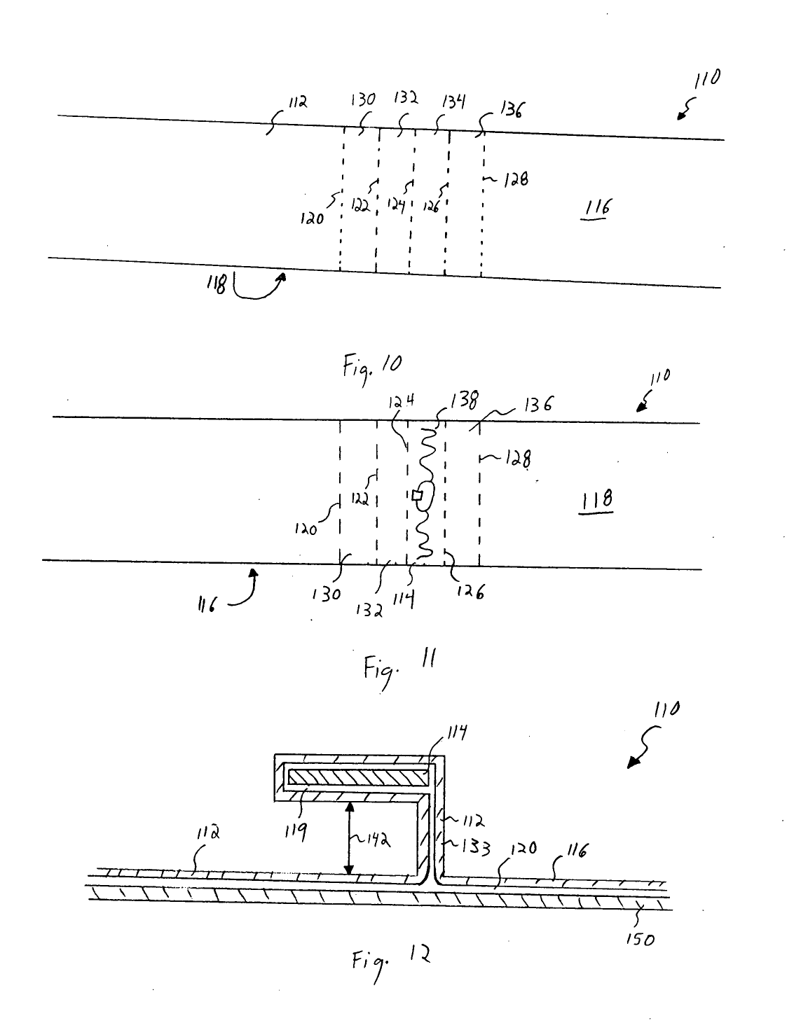

Referencing FIGS. 9-12, a second exemplary smart tag 110 is fabricated from a label material 112 and an RFID inlay 114. In this exemplary embodiment, the label material 112 includes a printing surface 116 and an opposite back surface 118 having an adhesive 119 applied thereto. The label material 112 is folded in accordance with a predefined pattern that includes five perforations 120, 122, 124, 126, 128 corresponding to four zones 130, 132, 134, 136 between the perforations. The folding operation is operative to form a wall 133 coupled to an encapsulated RFID portion 140.

Assembly of the second exemplary smart tag 110 includes orienting the label material 112 to expose the adhesive backed surface 118. This may be accomplished by inverting the label material 112 so that the underneath surface 118 faces upward, but need not be as the exemplary process may be carried out with the printing surface 116 facing upward. A bottom surface 138 of the RFID inlay 114 is positioned opposite the adhesive backed surface 118 and lengthwise aligned along one of the two the inner perforations 124, 126 so that the longitudinal portion of the inlay is generally aligned with the widthwise dimension of the label material 112. Pressure is applied to the bottom surface 138 of the RFID inlay 114 to mount the top surface to the adhesive backed surface 118 of the label material 112. A folding process is then carried out to fold over the remainder of the second zone 132 around the bottom surface 138 of the inlay 114, thereby encapsulating the inlay and forming the encapsulated RFID portion 140. Ideally, this folding will result in the two intermediate perforations 122, 126 being adjacent one another and allowing the encapsulated RFID portion 140 to tilt with respect to the wall 133. At substantially the same time, the vertical wall 133 is formed by pressing the adhesive exposed surfaces of the first and fourth zones 130, 136 together, with the two outermost perforations 120, 128 being adjacent one another in order to allow the wall 134 to tilt with respect to the printing surface 116 of the smart tag 110. If the above process is carried out well prior to end use of the tag 110, a tear away backing 150 may be applied to the tag 110 to protect against inadvertent adhesion until the tag is ready for end use. As would be apparent to one of ordinary skill in the art, it is not necessary that the entire back surface 118 of the label material 112 be coated with the adhesive in order for an exemplary smart tag 110 to be adhered to the product, container or other item that is to be tracked.

Dimensions for the exemplary smart tag 110 may depend on the end application and types of RFID components utilized. However, for purpose of explanation only, the wall 133 has a height of 1-10 millimeters, and a thickness of approximately 0.001-0.030 millimeters, with a length determined in part by the dimensions of the label material 112. Likewise, the encapsulated RFID portion 140 has a height of approximately 0.003-0.090 millimeters, and a width of approximately 2-20 millimeters, with a length determined in part by the lengths of the label material 112 and the RFID inlay 114. In this exemplary embodiment, the label material 112 has a thickness of approximately 0.004 millimeters.

Referring to FIG. 12, the RFID inlay 114 is spaced from the printed surface 116 of the tag 110 to reduce interference. This spacing is referred to as the spacing height 142. Typically, the spacing height 142 is between 1-10 millimeters, but it may depend on the angle between the printed surface 116 and the wall 133, as well as the angle between the wall 133 and the encapsulated RFID portion 140. Where the angle between the printed surface 116 and the wall 133, as well as the angle between the wall 133 and the encapsulated RFID portion 140, is at a right angle (i.e., perpendicular), the spacing height 142 of the encapsulated RFID portion 140 is approximately equal to the height of the wall 133. In this exemplary embodiment, the length of the encapsulated RFID portion 140 is greater than the height of the wall 133 to inhibit the RFID inlay 114 from being oriented perpendicularly with respect to the printed surface 116.

Exemplary RFID inlays as described in the foregoing embodiments are commercially available from the following vendors: (1) Alien Technologies ( ); (2) Avery Dennison RFID (www.rfid.averydennison.com); and, (3) UPM Raflatac (www.upmraflatac.com). Exemplary label material for use in the foregoing embodiments is available from UPM Raflatac ( ).

Following from the above description and invention summaries, it should be apparent to those of ordinary skill in the art that, while the methods and apparatuses herein described constitute exemplary embodiments of the present invention, the invention contained herein is not limited to this precise embodiment and that changes may be made to such embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. An RFID tag comprising:
a label material including a printing surface and an adhesion surface opposite the printing surface, the adhesion surface including an adhesive operative to mount at least one RFID inlay to the label material, the label material also including deformation indicia for a user to deform the label material to perpendicularly space the RFID inlay from the printing surface.

2. The RFID tag of claim 1, wherein the deformation indicia includes folding indicia where the label material is to be folded.

3. The RFID tag of claim 2, wherein the folding indicia includes perforations corresponding to folds to be made to the label material.

4. The RFID tag of claim 2, wherein the folding indicia includes visual marks corresponding to folds to be made to the label material.

5. The RFID tag of claim 2, wherein:
the folding indicia provide guidance for the user to fold the label material into a T-shaped projection by abutting portions of the adhesion surface; and
a horizontal aspect of the T-shaped projection includes the RFID inlay.

6. The RFID tag of claim 2, wherein:
the folding indicia provide guidance for the user to fold the label material into an inverted L-shaped projection by abutting portions of the adhesion surface; and
a horizontal aspect of the inverted L-shaped projection includes the RFID inlay.

7. The RFID tag of claim 2, wherein:
the folding indicia provide guidance for the user to fold the label material into an accordion shaped projection by abutting portions of the adhesion surface; and
a horizontal aspect of the accordion shaped projection includes the RFID inlay.

8. The RFID tag of claim 1, wherein the deformation indicia includes spacing indicia corresponding to those portions of the adhesion surface to be adhered directly to an end article.

9. The RFID tag of claim 1, wherein:
the deformation indicia provide guidance for the user to deform the label material into an encapsulating projection by more closely spacing portions of the adhesion surface with respect to one another; and
an apex of the encapsulating projection includes the RFID inlay.

10. A method for supplying an RFID tag comprising:
supplying an end user with an RFID label comprising a label material with a printing surface and an adhesive surface opposite the printing surface, the adhesive surface including an RFID inlay mounted thereto; and
supplying instructions to an end user on how to deform the label material to form an RFID tag after the printing surface has been printed with information, where the RFID inlay is perpendicularly spaced from the printing surface of the RFID tag by deforming the label material.

11. The method of claim 10, wherein the act of supplying the end user with an RFID label includes supplying the end user with a label material having perforations to facilitate folding of the label material.

12. The method of claim 11, wherein the perforations allow the user to fold the label material at the perforations to form at least one of a T-shaped projection, an inverted L-shaped projection, and an accordion-shaped projection.

13. The method of claim 11, wherein:
the instructions guide the user to fold the label material to form at least one of a T-shaped projection, an inverted L-shaped projection, and an accordion-shaped projection.

14. The method of claim 11, wherein the act of supplying instructions includes instructions for deforming the label material to form a bulb-shaped projection, where an apex of the bulb-shaped projection includes the RFID inlay.

15. A method of fabricating an RFID label comprising:
utilizing a label material having a printing surface and an adhesion surface opposite the printing surface, where the adhesion surface includes an adhesive applied thereto, where the label material also includes deformation indicia; and
mounting an RFID inlay to the adhesion surface using the adhesive, where the RFID inlay is aligned with the deformation indicia.

16. A method of fabricating an RFID tag comprising:
printing onto a printing surface of a label material, where the printing surface is defined in party by an X-Y plane;
encoding an RFID chip concurrent with the act of printing;
removing at least a portion of a backing material from an adhesive layer of the label material to expose an adhesive applied to the label material; and
deforming a portion of the label material onto itself, thereby trapping the RFID inlay between the label material so that the RFID is spaced apart in a Z-axis direction from the X-Y plane of the printing surface between 3 to 10 millimeters.

17. The method of claim 16, wherein:
the act of deforming the portion of the label material further comprises folding the label material in accordance with folding indicia associated with the label material; and
the act of deforming the portion of the label material further comprises folding the label material into a T-shaped projection.

18. The method of claim 16, wherein:
the act of deforming the portion of the label material further comprises folding the label material in accordance with folding indicia associated with the label material; and
the act of deforming the portion of the label material further comprises folding the label material into an L-shaped projection.

19. The method of claim 16, wherein:
the act of deforming the portion of the label material further comprises folding the label material in accordance with folding indicia associated with the label material; and
the act of deforming the portion of the label material further comprises folding the label material into an accordion shaped projection.

20. The method of claim 16, wherein:
the act of deforming the portion of the label material further comprises deforming the label material in accordance with spacing indicia associated with the label material; and
the act of deforming the portion of the label material further comprises deforming the label material into a concentric shaped projection.

21. A method of fabricating an RFID label, the method comprising repetitively laying out an RFID tag pattern on a label material, the RFID tag pattern including a plurality of perforations on the label material, where at least one of the perforations corresponds to a fold in an eventual RFID tag, the RFID tag pattern also including a separation feature for separating adjacent RFID labels from one another, the RFID tag pattern also including an RFID inlay mounting site where the RFID structure is to be mounted to the RFID label.

22. A smart tag comprising:
an inlay and a face material;
the face material is formed to include a base component and a projection component; and
the projection component having at least a first leg and a second leg, whereby the second leg rests at least 1 millimeter apart from the base, and the second leg is coupled to the inlay.

23. The smart label of claim 22, wherein the second leg rests generally parallel to the base.

24. The smart label of claim 22, wherein the face material that forms the base component and the projection component is a continuous sheet.

25. The smart label of claim 22, wherein the projection has a T-shaped cross-section.

26. The smart label of claim 22, wherein the projection has a L-shaped cross-section.

27. The smart label of claim 22, wherein the angle between the second leg and the first leg forms an acute angle.

28. A smart label comprising:
an inlay and a face material;
the face material is formed to include a base component and a projection component; and
the projection component having at least a first leg and a second leg, whereby the first leg is coupled to the base, the second leg is coupled to the first leg, and the inlay is coupled to the second leg; the inlay positioned a distance apart from the base.

29. The smart label of claim 28, wherein the inlay rests generally parallel to the base.

30. A smart label comprising:
an inlay and a face material; and
the face material formed to include a base component and a projection component, whereby at least one surface of the projection component is coupled to the inlay and rests a distance apart from the base.

31. A smart label of claim 30, wherein the surface of the projection that is coupled to the inlay rests generally parallel to the base.

32. A method for making a smart label with spacing, the method comprising:
providing a face material having a face surface and a back surface;
adhering an RFID inlay to the back surface of the face material; and
folding the face material to provide a base and a projection, whereby the RFID inlay is adhered to a portion of the projection and said portion of the projection rests generally parallel to the base.

33. The method of claim 32, wherein the back surface of the face material is coated with an adhesive.

34. The method of claim 32, wherein the face material encapsulates the RFID inlay.

35. The method of claim 32, wherein the face material is a continuous sheet.

36. The method of claim 32, wherein the face material is perforated to assist in forming the projection and base.
